(19) United States
(12) Patent Application Publication
(10) Pub. No.: US 2010/0098258 A1
(43) Pub. Date: Apr. 22, 2010

(54) SYSTEM AND METHOD FOR GENERATING MULTICHANNEL AUDIO WITH A PORTABLE ELECTRONIC DEVICE

(76) Inventor: Karl Ola Thorn, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/255,828

(22) Filed: Oct. 22, 2008

(51) Int. Cl. H04R 5/00

(52) U.S. Cl. 381/1; 382/100

(57) ABSTRACT

An electronic device manipulates a digital video having a video portion and an audio portion to encode the audio portion into a multichannel format. The electronic device may include an audio receiver for receiving the audio portion, and an image analyzer for receiving the video portion and determining at least one directional component of audio from an audio source. To determine the directional component, the image analyzer may include an image locator for determining a location of an audio source, and an orientation detector for determining an orientation of the audio source. An audio encoder may receive an input of the audio portion and the directional component, and the encoder may encode the audio portion in a multichannel format based on the directional component of audio from the audio source. The system may be applied to a plurality of audio sources in a digital video.

### TECHNICAL FIELD OF THE INVENTION

The present invention relates to sound reproduction in a portable electronic device, and more particularly to a system and methods for generating multichannel audio with a portable electronic device.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera (still and/or video), an Internet browser for accessing news and information, an audiovisual media player, a messaging device (text, audio, and/or visual messages), a gaming device, a personal organizer, and have other functions as well. Contemporary portable electronic devices, therefore, commonly include media player functionality for playing audiovisual content.

Generally as to audiovisual content, there have been improvements to the audio portion of such content. In particular, three-dimensional (“3D”) audio may be reproduced to provide a more realistic sound reproduction. Surround sound technologies are known in the art and provide a directional component to mimic a 3D sound environment. For example, sounds that appear to come from the left in the audiovisual content will be heard predominantly through a left-positioned audio source (e.g., a speaker), sounds that appear to come from the right in the audiovisual content will be heard predominantly through a right-positioned audio source, and so on. In this manner, the audio content as a whole may be reproduced to simulate a realistic 3D sound environment.

To generate surround sound, sound may be recorded and encoded in a number of discrete channels. When played back, the encoded channels may be decoded into multiple channels for playback. Sometimes, the number of recorded channels and playback channels may be equal, or the decoding may convert the recorded channels into a different number of playback channels. The playback channels may correspond to a particular number of speakers in a speaker arrangement. For example, one common surround sound audio format is denoted as “5.1” audio. This system may include five playback channels which may be (though not necessarily) played through five speakers—a center channel, left and right front channels, and left and right rear channels. The “point one” denotes a low frequency effects (LFE) or bass channel, such as may be supplied by a subwoofer. Other common formats provide for additional channels and/or speakers in the arrangement, such as 6.1 and 7.1 audio. With such multichannel arrangements, sound may be channeled to the various speakers in a manner that simulates a 3D sound environment. In addition, sound signal processing may be employed to simulate 3D sound even with fewer speakers than playback channels, which is commonly referred to as “virtual surround sound”.

For a portable electronic device, 3D sound reproduction has been attempted in a variety of means. For example, the device may be connected to an external speaker system, such as a 5.1 speaker system, that is configured for surround sound or other 3D or multichannel sound reproduction. An external speaker system, however, limits the portability of the device during audiovisual playback. To maintain portability, improved earphones and headsets have been developed that mimic a 3D sound environment while using only the left and right ear speakers of the earphones or headset. Such enhanced earphones and headsets may provide a virtual surround sound environment to enhance the audio features of the content without the need for the numerous speakers employed in an external speaker surround sound system.

External speaker systems, or 3D-enhanced portable earphones and headsets, often prove sufficient when the audiovisual content has been professionally generated or otherwise generated in a sophisticated manner. Content creators typically generate 3D audio by recording multiple audio channels, which may be recorded by employing multiple microphones at the time the content is created. By properly positioning the microphones, directional audio components may be encoded into the recorded audio channels. Additional processing may be employed to enhance the channeling of the multichannel recording. The audio may be encoded into one of the common multichannel formats, such as 5.1, 6.1, etc. The directional audio components may then be reproduced during playback provided the player has the appropriate decoding capabilities, and the speaker system (speakers, earphones, headset, etc.) has a corresponding 3D/multichannel surround sound or virtual surround sound reproduction capability.

These described systems, however, have proven less effective for user-created content. It is common now for portable electronic devices to include a digital video recording function for recording audiovisual content, such as a digital video having a video portion and an audio portion. Examples of such devices include a dedicated digital video camera, or multifunction devices (such as a mobile telephone, PDA, gaming device, etc.) having a digital video function. Regardless of the type, portable electronic devices lo typically have only one microphone for recording the audio portion of audiovisual content. With only a single microphone, the generation of 3D or multichannel audio would require sophisticated or specialized sound signal processing that is not usually found in consumer-oriented portable electronic devices. 3D or multichannel audio thus typically cannot be generated for user-created content in a portable electronic device.

In a separate field of art, eye tracking and gaze detection systems have been contemplated. Eye tracking is the process of measuring the point of gaze and/or motion of the eye relative to the head. The most common contemporary method of eye tracking or gaze direction detection comprises extracting the eye position relative to the head from a video image of the eye. In addition to eye tracking, other forms of face detection are being developed. For example, one form of face detection may detect particular facial features, such as whether an individual is smiling or blinking. To date, however, such technologies have not been fully utilized.

### SUMMARY

Accordingly, there is a need in the art for an improved system and methods for the production of 3D or multichannel audio in a portable electronic device. In particular, there is a need in the art for an improved system and methods for production of 3D or multichannel audio in a portable electronic device that does not require more than the single microphone commonly present in portable electronic devices.

An electronic device is provided for manipulating a digital video having a video portion and an audio portion to encode the audio portion into a 3D or multichannel format. The electronic device may include an audio receiver for receiving the audio portion of the digital video, and an image analyzer for receiving the video portion of the digital video and determining at least one directional component of audio from an audio source in the digital video. To determine the directional component, the image analyzer may include an image locator for determining a location of an audio source within the digital video, and an orientation detector for determining an orientation of the audio source. The orientation detector may include a face detection module that determines the orientation of a person that is an audio source based on the motion and configuration of the subject person's facial features. The location and orientation of an audio source are employed to determine a directional component of audio from the audio source. An audio encoder may receive an input of the audio portion and the at least one directional component, and the encoder may encode the audio portion in a multichannel format based on the at least one directional component of audio from the audio source.

Therefore, according to one aspect of the invention, an electronic device is provided for manipulating a digital video having a video portion and an audio portion. The electronic device comprises an audio receiver for receiving the audio portion of the digital video, and an image analyzer for receiving the video portion of the digital video and determining at least one directional component of audio from an audio source in the digital video. An audio encoder receives an input of the audio portion and the at least one directional component, wherein the encoder encodes the audio portion in a multichannel format based on the at least one directional component of audio from the audio source.

According to one embodiment of the electronic device, the electronic device further comprises a camera assembly for generating the video portion of the digital video that is received by the image analyzer, and a microphone for gathering the audio portion of the digital video that is received by the audio receiver.

According to one embodiment of the electronic device, the electronic device further comprises a motion sensor for detecting a motion of the electronic device, and a motion analyzer for determining a directional component of audio from the audio source in the digital video based on the motion of the electronic device. The encoder further encodes the audio portion in a multichannel format based on the directional component of audio from the audio source as determined by the motion analyzer.

According to one embodiment of the electronic device, the electronic device further comprises a memory for storing the digital video, wherein the image analyzer receives the video portion by extracting the video portion from the stored digital video, and the audio receiver receives the audio portion by extracting the audio portion from the stored digital video.

According to one embodiment of the electronic device, the electronic device further comprises a network interface for accessing the digital video from a network, wherein the image analyzer receives the video portion by extracting the video portion from the accessed digital video, and the audio receiver receives the audio portion by extracting the audio portion from the accessed digital video.

According to one embodiment of the electronic device, the image analyzer comprises an image locator for locating an audio source within the video portion of the digital video, and the image analyzer determines the directional component of audio from the audio source based on the audio source's location within the video portion.

According to one embodiment of the electronic device, the image analyzer further comprises an orientation detector for determining the orientation of an audio source within the video portion of the digital video to determine an orientation of the audio source, and the image analyzer further determines the directional component of audio from the audio source based on the orientation of the audio source within the video portion.

According to one embodiment of the electronic device, the orientation detector includes a face detection module that determines the orientation of an audio source that is a person based upon a configuration of facial features of the audio source.

According to one embodiment of the electronic device, the image analyzer includes an interference detector for detecting an object in the video portion that interferes with the image of an audio source in the video portion of the digital video, such that the encoder encodes the multichannel audio without disruption from the interfering object.

According to one embodiment of the electronic device, the image analyzer determines at least one directional component of audio from each of a plurality of audio sources in the digital video, and the encoder encodes the audio portion in a multichannel format based on the at least one directional component of audio from the plurality of audio sources.

According to one embodiment of the electronic device, the image analyzer determines a plurality of directional components of audio from each of a plurality of audio sources in the digital video, and the encoder encodes the audio portion in a multichannel format based on the plurality of directional components of audio from the plurality of audio sources.

According to another aspect of the invention, a method of encoding multichannel audio for a digital video having a video portion and an audio portion comprises the steps of receiving the audio portion of the digital video, receiving the video portion of the digital video and determining at least one directional component of audio from an audio source in the digital video, inputting the audio portion and the at least directional component into a multichannel audio encoder, and encoding the audio portion in a multichannel format based on the at least one directional component of audio from the audio source.

According to one embodiment of the method, the method further comprises generating the digital video with an electronic device, detecting a motion of the electronic device, and determining a directional component of audio from the audio source in the digital video based on the motion of the electronic device. The encoder further encodes the audio portion in a multichannel format based on the directional component of audio from the audio source as determined from the motion of the electronic device.

According to one embodiment of the method, the method further comprises storing the digital video in a memory in an electronic device, retrieving the digital video from the memory, and extracting the video portion and the audio portion from the stored digital video.

According to one embodiment of the method, determining the at least one directional component comprises locating an audio source within the video portion of the digital video, and determining the directional component of audio from the audio source based on the audio source's location within the video portion.

According to one embodiment of the method, determining the at least one directional component further comprises determining an orientation of an audio source within the video portion of the digital video, and further determining the directional component of audio from the audio source based on the orientation of the audio source within the video portion.

According to one embodiment of the method, determining the orientation of an audio source includes performing face detection to determine the orientation of an audio source that is a person based upon a configuration of facial features of the audio source.

According to one embodiment of the method, the method further comprises detecting an object in the video portion that interferes with the image of an audio source in the video portion of the digital video, and encoding the audio portion without disruption from the interfering object.

According to one embodiment of the method, the method further comprises determining at least one directional component of audio from each of a plurality of audio sources in the digital video, and encoding the audio portion in a multichannel format based on the at least one directional component of audio from each of the plurality of audio sources.

According to one embodiment of the method, the method further comprises establishing a video conference telephone call, wherein each of the plurality of audio sources is a participant in the video conference call, and encoding the audio portion to simulate each participant's relative position in the video conference call.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic diagram of an exemplary electronic device for use in accordance with an embodiment of the present invention.

FIG. 2 is a schematic block diagram of operative portions of the electronic device of FIG. 1.

FIG. 3 depicts a sequence of images constituting a video portion of an exemplary digital video.

FIG. 4 depicts an exemplary sequence of alteration of the orientation of a subject in a digital video.

FIG. 5 is a schematic block diagram of operative portions of an exemplary 3D audio application.

FIG. 6 is a flow chart depicting an exemplary method of generating 3D or multichannel audio for a digital video.

FIG. 7 is a schematic diagram of an exemplary video conferencing system.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

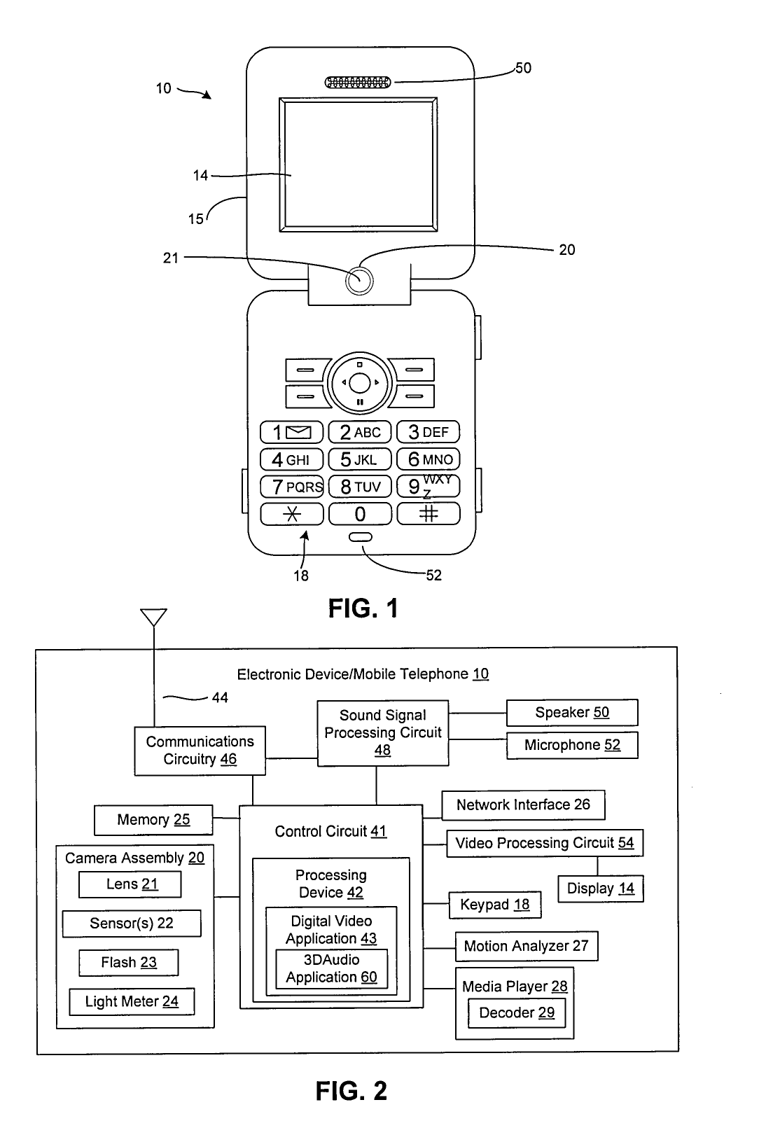

With reference to FIG. 1, an exemplary electronic device 10 is embodied in a portable electronic device having a digital video function. In FIG. 1, the exemplary portable electronic device is depicted as a mobile telephone 10. Although the following description is made in the context of a conventional mobile telephone, it will be appreciated that the invention is not intended to be limited to the context of a mobile telephone and may relate to any type of appropriate electronic device with a digital video function, including a digital camera, digital video camera, mobile PDA, other mobile radio communication device, gaming device, portable media player, or the like. It will be appreciated that the term “digital video” as used herein includes audiovisual content that may include a video portion and an audio portion. In addition, although the description herein pertains primarily to content having both a video and an audio portion, comparable principles may also be applied to reproducing only the audio portion of content independent of or with no associated video portion.

FIG. 1 depicts various external components of the exemplary mobile telephone 10, and FIG. 2 represents a functional block diagram of operative portions of the mobile telephone 10. Mobile telephone 10 may be a clamshell phone with a flip-open cover 15 movable between an open and a closed position. In FIG. 1, the cover is shown in the open position. It will be appreciated that mobile telephone 10 may have other configurations, such as a “block” or “brick” configuration, slide cover configuration, swivel cover configuration, or others.

Mobile telephone 10 may include a primary control circuit 41 that is configured to carry out overall control of the functions and operations of the mobile telephone. The control circuit 41 may include a processing device 42, such as a CPU, microcontroller or microprocessor. Among their functions, to implement the features of the present invention, the control circuit 41 and/or processing device 42 may comprise a controller that may execute program code embodied as the digital video application 43 having a 3D audio application 60. It will be apparent to a person having ordinary skill in the art of computer programming, and specifically in application programming for cameras, mobile telephones or other electronic devices, how to program a mobile telephone to operate and carry out logical functions associated with applications 43 and 60. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention.

Mobile telephone 10 also may include a camera assembly 20. The camera assembly 20 constitutes an image generating device for generating a digital image, such as digital still photographs or digital moving video images. The camera assembly 20 may include a lens 21 that faces outward and away from the user for taking the still photographs or moving digital video images of subject matter opposite the user. Camera assembly 20 may also include one or more image sensors 22 for receiving the light from the lens to generate the images. Camera assembly 20 may also include other features common in conventional digital still and video cameras, such as a flash 23, light meter 24, and the like.

Mobile telephone 10 has a display 14 viewable when the clamshell telephone is in the open position. The display 14 displays information to a user regarding the various features and operating state of the mobile telephone, and displays visual content received by the mobile telephone and/or retrieved from a memory 25. Display 14 may be used to display pictures, video, and the video portion of multimedia content. For photograph or digital video functions, the display 14 may be used as an electronic viewfinder for the camera assembly 20. The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 25, derived from an incoming video data stream, or obtained by any other suitable method. In accordance with embodiments of the present invention, the display 14 may display the video portion of digital video images captured by the camera assembly 20 or otherwise played by the electronic device 10.

The mobile telephone 10 further includes a sound signal processing circuit 48 for processing audio signals. Coupled to the sound processing circuit 48 are a speaker 50 and microphone 52 that enable a user to listen and speak via the mobile telephone as is conventional. For example, signals may be received and transmitted via communications circuitry 46 and antenna 44. As further described below, in embodiments of the present invention, the microphone 52 may be employed to gather the audio portion of audiovisual content created by the user.

The present invention provides for the generation of 3D or multichannel audio in connection with audiovisual content created by the user with the mobile telephone 10. For example, a user may employ the digital video function 43 to create a digital video having a video portion and an audio portion. The camera assembly 20 may generate the video portion, and the microphone 52 may gather the audio portion. The digital video function 43 may merge the two components into a digital video having both the video portion and the audio portion.

The digital video function 43 may be executed by a user in a variety of ways. For example, mobile telephone 10 may include a keypad 18 that provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others, or directional navigation keys. Some or all of the keys may be used in conjunction with the display as soft keys. Keys or key-like functionality also may be embodied as a touch screen associated with the display 14. The digital video function 43, therefore, may be selected with a dedicated key on keypad 18, by selection from a menu displayed on the display 14, or by any suitable means.

In this exemplary electronic device 10, there is only one microphone 52, which, as stated above, would not typically be sufficient for recording 3D or multichannel audio directly. If the digital video has been created in a manner other than by the user of electronic device 10, it is similarly presumed herein that the digital video was not created with multichannel or 3D audio features. To generate 3D or multichannel audio, the digital video function 43 may include a 3D audio application 60. As stated above, the application 60 may be embodied as executable program code that may be executed by the control circuit 41. It will be apparent to a person having ordinary skill in the art of computer programming, and specifically in application programming for cameras, mobile telephones or other electronic devices, how to program a mobile telephone to operate and carry out logical functions associated with application 60. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention. Furthermore, although the application 60 has been described as being part of the digital video function 43, application 60 or portions thereof may be independent of the digital video function 43.

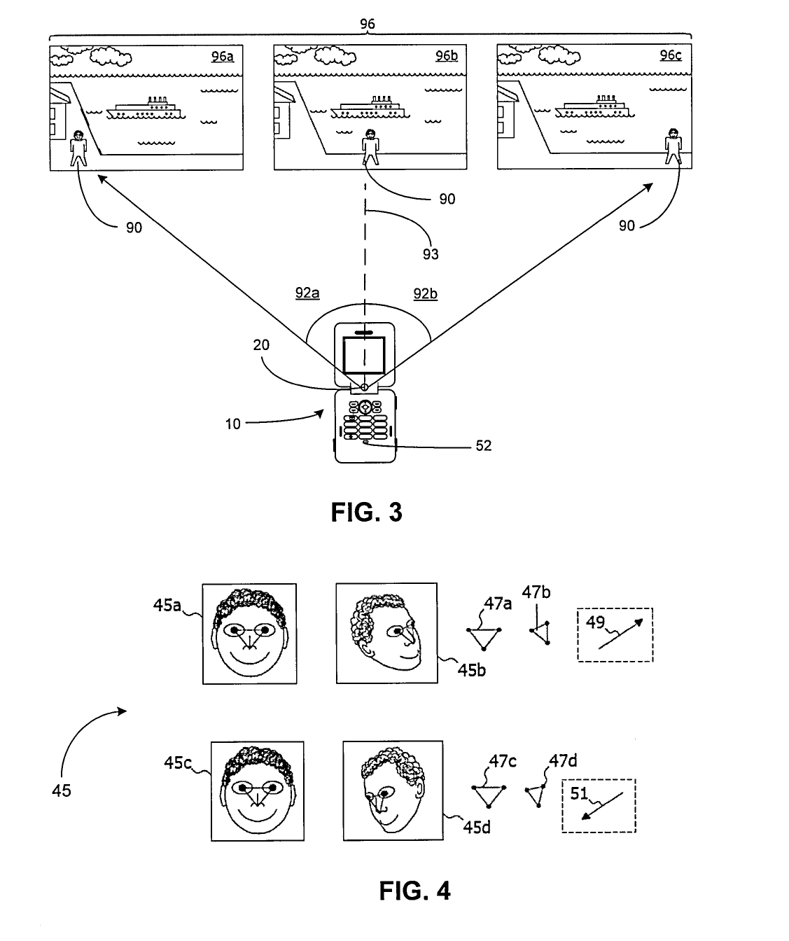

FIG. 3 depicts an exemplary portion 96 of an exemplary digital video. As seen in the figure, the digital video portion 96 may comprise a sequence of images 96a-c that make up the digital video. A subject 90 in the digital video may be an audio source. For example, in FIG. 3 the subject 90 is a person who may be speaking while the digital video is being recorded. It will be appreciated that a directional component of the audio from the subject 90 may be affected by two parameters. First, as the subject moves, the audio originates from a different direction relative to the digital video camera of the electronic device. In addition, the directional component of the audio may change as the subject changes his orientation relative to the video camera. For example, referring briefly to FIG. 4, if the subject is a person, the directional component of the audio from the person may change as the subject reorients his face 45 relative to the video camera. As further described below, each of these parameters—the location of the subject and the orientation of the subject—may be employed to generate 3D or multichannel audio for the digital video.

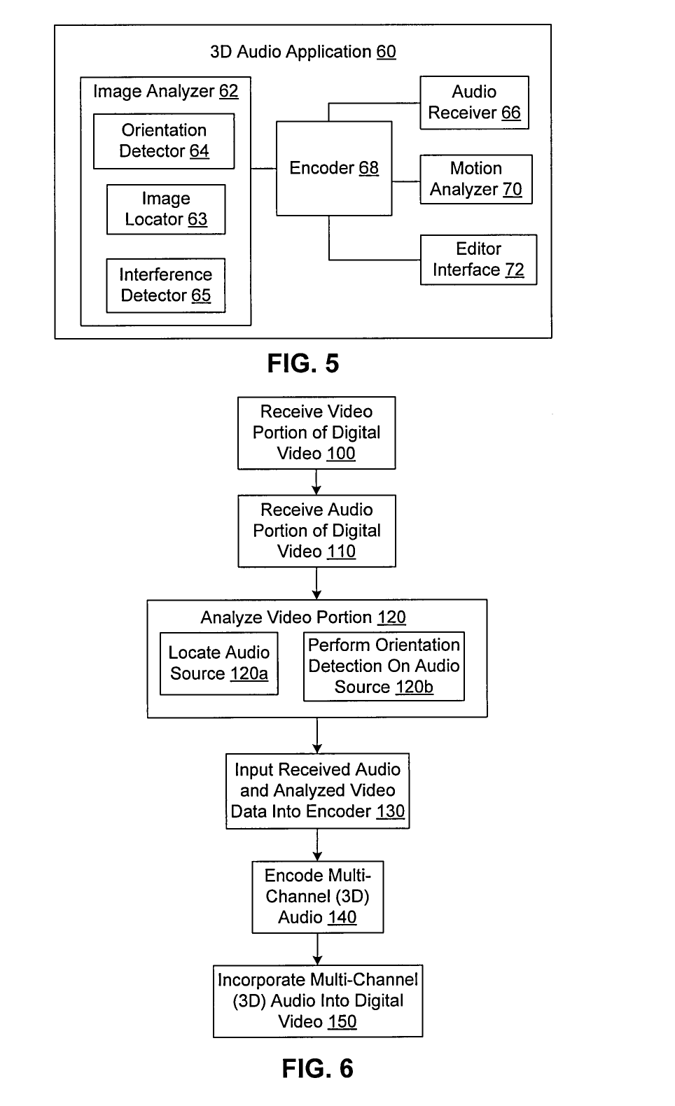

FIG. 5 is a schematic block diagram of operative portions of an exemplary 3D audio application 60. The application 60 may include an image analyzer 62 that receives a video portion of a digital video, and an audio receiver 66 that receives the audio portion of a digital video. In one embodiment, the video portion and audio portion may be received by application 60 in real time as a digital video is generated. For example, the video portion may be received in real time from the camera assembly 20, and the audio portion may be received in real time from the microphone 52 via the sound signal processing circuit 48. In an alternative embodiment, the digital video may be a previously created video file that includes the video portion and the audio portion. The video and audio portions may then be extracted from the digital video file for processing. For example, the video file may be retrieved from the internal memory 25, downloaded from an external storage device, streamed from a network video feed, or by other conventional means. Accordingly, the 3D audio may be generated in the manner described herein either in real time as a user generates the digital video with the portable electronic device, or as a post-processing function applied to a previously created and/or non-user created digital video.

The image analyzer may include an image locator 63 for determining the location of an audio source in a digital video. The image locator may identify a subject as an audio source by employing image recognition techniques (such as object recognition, edge detection, silhouette recognition or others) in combination with the audio received by the audio receiver 66. As stated above, one parameter for generating 3D-audio may be an audio source's location relative to the digital video camera of the electronic device that generated the video. Referring again to FIG. 3, as the subject moves from left to right in the digital video, the subject's position changes relative to the camera assembly. A realistic audio reproduction would reflect this change in position such that when the subject is to the left of the camera assembly (frame 96a), the audio reproduction would be more concentrated in a left audio channel. When the subject is to the right of the camera assembly (frame 96c), the audio reproduction would be more concentrated in a right audio channel. When the subject is directly in front of the camera assembly (frame 96b), the audio reproduction would be more concentrated in a center audio channel, and/or divided substantially equally between left and right audio channels.

The image locator 63 of the image analyzer 62 may determine a subject's change in location as the subject moves in the digital video. For example, as to frame 96a an angle formed between a line drawn to the subject 90 and a normal 93 to the camera assembly is 92a. Such angle is zero in frame 96b when the subject is directly in front of the camera assembly, and 92b in frame 96c when the subject has moved to the right. In this manner, the image locator may track a subject as the subject moves in the digital video. In addition, although in this example the movement is from left to right, other orientation changes, such as up versus down or nearer versus farther may also be determined.

As stated above, another parameter for generating 3D or multichannel audio may be an audio source's orientation relative to the camera assembly that generated the digital video. The image analyzer 62, therefore, may also include an orientation detector 64 for determining an audio source's orientation relative to the camera assembly. In one embodiment, the orientation detector 64 may include a face detection module for determining a human subject's orientation relative to the camera assembly based upon a configuration (or changes thereof) of the facial features of the audio source.

FIG. 4 depicts an exemplary sequence of alteration of the orientation of a human subject in a digital video. The orientation detector/face detection module 64 may detect the motion and orientation of a subject's facial features, particularly the movement and orientation of the user's eyes and adjacent facial features. Such movement and orientation may be determined by object recognition, edge detection, silhouette recognition or other means for detecting motion of any item or object detected within a sequence of images. The movement of the facial features may then be converted into a directional vector that corresponds to a directional component of audio emanating from the subject.

For example, in FIG. 4 elements 45a-d represent a sequence of changes in the orientation of a subject as may be detected by the orientation detector/face detection module 64. Thus, the orientation detector/face detection module 64 monitors the sequence of motion represented by frames 45a-45d. Initially in this example, the subject is facing forward as seen in frame 45a. The orientation detector 64 may detect that the subject has turned his head to the right, as depicted in the thumbnail frames from 45a to 45b. The orientation detector 64 may define a direction vector 49 corresponding to the orientation of at least a portion of the user's face, as represented, for example, by the change in configuration and orientation of the user's eyes and adjacent facial features. The direction vector 49 may be derived from determining the relative displacement and distortion of a triangle formed by the relative position of the user's eyes and nose tip within the sequence of images captured by the camera assembly. For example, triangle 47a represents the relative positions of the user's eyes and nose within frame 45a, and triangle 47b represents the relative position of the user's eyes and nose within frame 45b. The relative displacement between triangle 47a and 47b, along with the relative distortion, indicate that the user has looked to the right as represented by direction vector 49. Similarly, when the user, as depicted in frame 45c, turns his head to the left as depicted in frame 45d, the orientation detector 64 may determine another direction vector 51 corresponding to the direction of the orientation of the user's face as is apparent from triangles 47c and 47d. In a realistic audio reproduction, there should be a commensurate change in the audio to reflect when the subject is speaking away from (or at least not directly toward) the camera assembly.

As stated above, the audio receiver 66 receives the audio that is gathered by the microphone 52. The microphone audio is inputted into an encoder 68 from the audio receiver 66. In addition, directional data from the image analyzer 62, including the image locator 63 and orientation detector 64, likewise is inputted into the encoder 68. The encoder may then reprocess the microphone audio based on the directional data generated by the image analyzer to generate 3D or multichannel audio for the digital video. For example, the encoder may encode the audio as multiple channel audio depending upon the location and orientation of a subject, as determined by the image locator and the orientation detector. The audio may be encoded in a standard format (such as 5.1, 6.1 etc.) or in some other format developed or defined by a user. In this manner, a realistic 3D audio reproduction may be generated even if the audio portion of a digital video is initially gathered using only a single microphone.

In accordance with the above, FIG. 6 is a flow chart depicting an exemplary method of generating 3D or multichannel audio for a digital video. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 100 at which a video portion of a digital video is received. As described above, the video portion may be received by the image analyzer 62. At step 110, an audio portion of the digital video may be received, such as by the audio receiver 66. At step 120, the video portion may be analyzed. For example, step 120a may include locating an audio source within the video portion with the image locator 63. By locating an audio source, a directional component of audio from the audio source may be determined. In addition, step 120b may include performing orientation detection on an audio source with the orientation detector 64 to determine the orientation of the audio source, which likewise may be employed to determine a directional component of audio from the audio source. If the audio source is a human subject, the orientation detector may perform face detection to determine the orientation of the audio source based upon a configuration (or changes thereof) of facial features of the audio source. At step 130, the received audio and analyzed image data may be inputted into an audio encoder, such as the encoder 68. At 140, the audio may be encoded into any multichannel audio format to generate a realistic 3D audio component for the digital video. At step 150, the multichannel audio may be incorporated into the digital video file so that the digital video may be played with the generated 3D or multichannel audio.

Referring to FIG. 2, the electronic device 10 may include a media player 28 having a decoder 29 for decoding multichannel or 3D audio. The decoder permits the audio to be outputted to a speaker system (whether external speakers, earphones, headset, etc.) in a multichannel format. It will be appreciated that although FIG. 2 depicts an electronic device having both the capability to generate and play black content with 3D or multichannel audio, such need not be the case. For example, the 3D audio may be encoded by one device, and the content incorporating the 3D audio may be transmitted to a second device having the media player and decoder for playback.

In addition, the 3D audio application 60 need not be present on any portable electronic device. For example, in one embodiment the 3D audio application may be resident on and accessed from a network server by any conventional means.

In accordance with the above exemplary embodiments, the digital video may be created by the electronic device 10 itself with the digital video function 43. In operation, the video portion may be generated by the camera assembly 20 as is conventional for a digital video camera. In addition, an audio portion of the digital video may be gathered by the microphone 52, which feeds into the sound signal processing circuit 48. The digital video function 43 merges the video and audio portions into a single digital video file, which may be stored in an internal memory such as the memory 25, played in real time, transmitted to an external device for storage or playback, or combinations thereof In one embodiment, in the manner described above the digital video may be enhanced with multichannel or 3D audio in real time as the digital video is created by the user with electronic device 10.

In other embodiments, the digital video may be created first, by the user or another, and then enhanced with multichannel or 3D audio encoding as part of a post-processing routine. Referring again to FIG. 2, for example the digital video may be stored in the internal memory 25 of the electronic device 10. The 3D audio application 60 may retrieve the digital video from the memory, and the image analyzer 62 and audio receiver 66 may respectively extract the video portion and the audio portion from the stored digital video. As another example, the electronic device 10 may include a network interface 26 for accessing the digital video over a wired or wireless network. The digital video may be accessed by downloading or streaming the digital video to the electronic device. The image analyzer 62 and audio receiver 66 then may respectively extract the video portion and the audio portion from the network accessed digital video.

The 3D audio application 60 may include other components for enhancing the quality of the audio reproduction. For example, referring again to FIG. 5, the image analyzer 62 may include an interference detector 65. It will be appreciated that during the creation of a digital video, an audio source may become non-viewable by the digital video camera. For example, an unintended object may move between the camera and the subject, which may disrupt the view of the subject even as audio from the subject audio source remains constant. The interference detector may act somewhat as a memory to store the image location and orientation data relating to the audio source during the period of the disrupted view. In this manner, the multichannel audio is continuously encoded based on the location and orientation of the subject audio source, despite the disrupted view.

Referring to FIGS. 2 and 5, in another embodiment the 3D audio application 60 may also account for motion of the camera as the digital video is created. It will be appreciated that motion of the camera likewise may alter the directional component of audio from an audio source relative to the position of the camera. For example, the electronic device 10 may include a motion sensor 27 for sensing the motion of the camera. The motion sensor may be an accelerometer or comparable device for detecting motion of an object. As the camera moves, the directional component of audio from an audio source may alter commensurately. In this embodiment, the 3D audio application 60 may include a motion analyzer 70 for receiving the input from the motion sensor. The motion analyzer may determine a directional component of audio from an audio source in the digital video based on the motion of the electronic device. The data from the motion analyzer may be inputted into the encoder 68 to be utilized in encoding the audio portion of the digital video in the 3D or multichannel format.

In another embodiment, the 3D audio application 60 may include an editor interface 72 by which a user may edit the multichannel audio. For example, a user may modify the volume of any of the channels, re-channel a portion or portions of the audio into different channels, and the like. A user may access the editor and input the edits using the keypad 18 and/or a menu system, or by any conventional means of accessing applications and inputting data or commands.

The above examples have generally been described in connection with determining a directional component for a single audio source in a digital video. The system may have sufficient sophistication to determine a plurality of directional components for an audio source, and/or a plurality of directional components for plurality of audio sources. In addition, as stated above, the audio sources need not be human subjects, but may be any type of audio source. For example, alternative or additional audio sources may include such objects as loudspeakers, dogs and other animals, environmental objects, and others. For non-human subjects, the orientation detector 64 may employ recognition techniques other than face detection. For example, the orientation detector may employ object recognition, edge detection, silhouette recognition or other means for detecting orientation of any item or object detected within an image or sequence of images corresponding to a digital video.

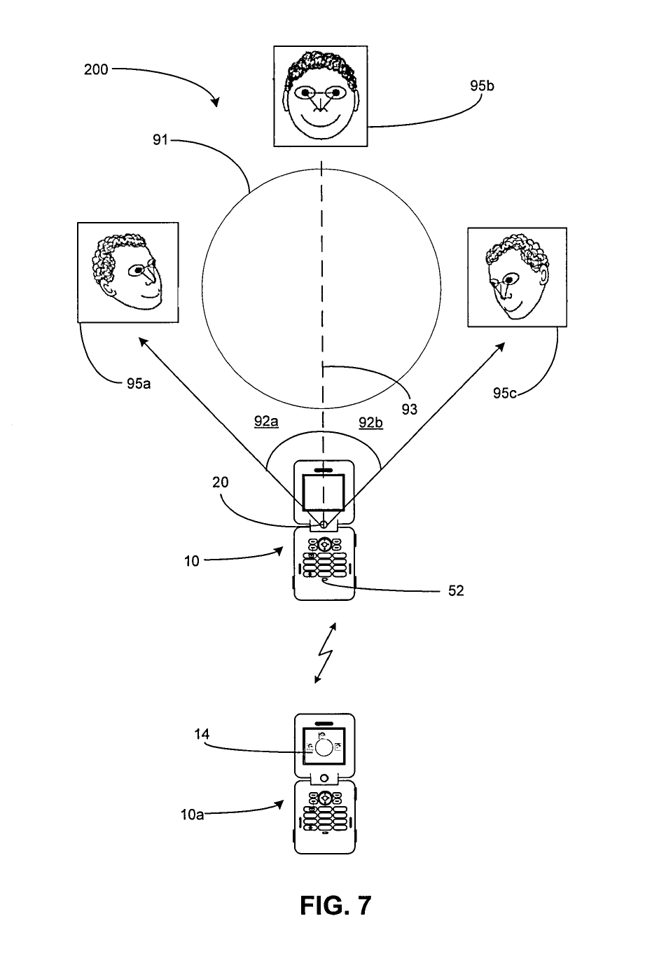

Referring to FIG. 7, multi-source functionality may be employed to create a video conferencing system 200. In this embodiment, three video conference call participants 95a, 95b, and 95c are represented at different locations around an exemplary conference table 91. The video conference call may be generated by an electronic device 10 having a camera assembly 20 and microphone 52. A realistic audio encoding and reproduction would simulate the various positions of each participant in the call such that audio (speech) from the subject 95a to the left of the camera assembly would be more concentrated in a left audio channel. Audio (speech) from the subject 95c to the right of the camera assembly would be more concentrated in a right audio channel, and audio (speech) from the subject 95b directly in front of the camera assembly would be more concentrated in a center audio channel, and/or divided substantially equally between left and right audio channels.

Similar to the system depicted in FIG. 3, an angle may be formed between lines drawn to each of the subjects 95a, 95b, and 95c, and a normal 93 to the camera assembly. (Such angle is zero as to subject 95b who is directly in front of the camera assembly.) In this manner, the image locator may determine a directional component of the audio from each subject based upon the subject's location in the video conference call relative to the camera assembly. It will be appreciated that this system may be employed as to any number of conference call participants.

The audio portion of the conference call may thus be encoded to simulate each participant's relative position in the call. A video conference call feed may then be transmitted to a remote participant who is using the mobile telephone 10a, as indicated by the jagged arrow in FIG. 7. Assuming the mobile 10a is equipped with a multichannel decoder and speaker system (external speakers, virtual surround sound earphones, or headset), the remote participant will hear each participant 95a-c as if the participants are sitting around the table 91. In one embodiment, the remote participant may receive only the audio portion of the call. If so, the remote participant may more easily identify each speaker based on the directional encoding of the audio. Alternatively, a video component of the call may be displayed on the display 14 of the mobile telephone 10a. Even in this situation, the remote participant may attain better enjoyment of the call because the audio will match the physical positioning of each speaker. It will also be appreciated that it does not matter which electronic device (10 or 10a) determines and encodes the multichannel video. Either device may analyze the video portion of the video conference call and encode the audio portion in a multichannel format.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. An electronic device for manipulating a digital video having a video portion and an audio portion, the electronic device comprising:
an audio receiver for receiving the audio portion of the digital video;
an image analyzer for receiving the video portion of the digital video and determining at least one directional component of audio from an audio source in the digital video; and
an encoder for receiving an input of the audio portion and the at least one directional component, wherein the encoder encodes the audio portion in a multichannel format based on the at least one directional component of audio from the audio source.

2. The electronic device of claim 1, further comprising:
a camera assembly for generating the video portion of the digital video that is received by the image analyzer; and
a microphone for gathering the audio portion of the digital video that is received by the audio receiver.

3. The electronic device of claim 2, further comprising:
a motion sensor for detecting a motion of the electronic device; and
a motion analyzer for determining a directional component of audio from the audio source in the digital video based on the motion of the electronic device;
wherein the encoder further encodes the audio portion in a multichannel format based on the directional component of audio from the audio source as determined by the motion analyzer.

4. The electronic device of claim 1, further comprising a memory for storing the digital video, wherein the image analyzer receives the video portion by extracting the video portion from the stored digital video, and the audio receiver receives the audio portion by extracting the audio portion from the stored digital video.

5. The electronic device of claim 1, further comprising a network interface for accessing the digital video from a network, wherein the image analyzer receives the video portion by extracting the video portion from the accessed digital video, and the audio receiver receives the audio portion by extracting the audio portion from the accessed digital video.

6. The electronic device of claim 1, wherein the image analyzer comprises an image locator for locating an audio source within the video portion of the digital video, and the image analyzer determines the directional component of audio from the audio source based on the audio source's location within the video portion.

7. The electronic device of claim 6, wherein the image analyzer further comprises an orientation detector for determining the orientation of an audio source within the video portion of the digital video to determine an orientation of the audio source, and the image analyzer further determines the directional component of audio from the audio source based on the orientation of the audio source within the video portion.

8. The electronic device of claim 7, wherein the orientation detector includes a face detection module that determines the orientation of an audio source that is a person based upon a configuration of facial features of the audio source.

9. The electronic device of claim 1, wherein the image analyzer includes an interference detector for detecting an object in the video portion that interferes with the image of an audio source in the video portion of the digital video, such that the encoder encodes the multichannel audio without disruption from the interfering object.

10. The electronic device of claim 1, wherein the image analyzer determines at least one directional component of audio from each of a plurality of audio sources in the digital video, and the encoder encodes the audio portion in a multichannel format based on the at least one directional component of audio from the plurality of audio sources.

11. The electronic device of claim 10, wherein the image analyzer determines a plurality of directional components of audio from each of a plurality of audio sources in the digital video, and the encoder encodes the audio portion in a multichannel format based on the plurality of directional components of audio from the plurality of audio sources.

12. A method of encoding multichannel audio for a digital video having a video portion and an audio portion, the method comprising the steps of:
receiving the audio portion of the digital video;
receiving the video portion of the digital video and determining at least one directional component of audio from an audio source in the digital video;
inputting the audio portion and the at least directional component into a multichannel audio encoder; and
encoding the audio portion in a multichannel format based on the at least one directional component of audio from the audio source.

13. The method of claim 12, further comprising:
generating the digital video with an electronic device;
detecting a motion of the electronic device; and
determining a directional component of audio from the audio source in the digital video based on the motion of the electronic device;
wherein the encoder further encodes the audio portion in a multichannel format based on the directional component of audio from the audio source as determined from the motion of the electronic device.

14. The method of claim 12, further comprising:
storing the digital video in a memory in an electronic device;
retrieving the digital video from the memory; and
extracting the video portion and the audio portion from the stored digital video.

15. The method of claim 12, wherein determining the at least one directional component comprises locating an audio source within the video portion of the digital video, and determining the directional component of audio from the audio source based on the audio source's location within the video portion.

16. The method of claim 15, wherein determining the at least one directional component further comprises determining an orientation of an audio source within the video portion of the digital video, and further determining the directional component of audio from the audio source based on the orientation of the audio source within the video portion.

17. The method of claim 16, wherein determining the orientation of an audio source includes performing face detection to determine the orientation of an audio source that is a person based upon a configuration of facial features of the audio source.

18. The method of claim 12, further comprising detecting an object in the video portion that interferes with the image of an audio source in the video portion of the digital video, and encoding the audio portion without disruption from the interfering object.

19. The method of claim 12, further comprising determining at least one directional component of audio from each of a plurality of audio sources in the digital video, and encoding the audio portion in a multichannel format based on the at least one directional component of audio from each of the plurality of audio sources.

20. The method of claim 19, further comprising
establishing a video conference telephone call, wherein each of the plurality of audio sources is a participant in the video conference call; and
encoding the audio portion to simulate each participant's relative position in the video conference call.
